(19) United States
(12) Patent Application Publication
(10) Pub. No.: US 2008/0249797 A1
(43) Pub. Date: Oct. 9, 2008

(54) Framework for modeling real estate assets based on genetics

(76) Inventor: Patrick P. Lecomte, Nevers (FR)

Correspondence Address: Mr. Patrick P. Lecomte, 22 rue PaulVaillant Couturier, Nevers, 58000, FR

(21) Appl. No.: 12/078,674

(22) Filed: Apr. 3, 2008

Related U.S. Application Data
(60) Provisional application No. 60/907,515, filed on Apr. 5, 2007.

(51) Int. Cl. G06Q 99/00

(52) U.S. Cl. 705/1

(57) ABSTRACT

Real estate assets are part of a category of assets called heterogeneous assets. Each property is different and as a result it is difficult to derive a consistent pricing model for real estate assets. The specification presents an innovative framework for modelling real estate assets. This framework based on genetics enables the identification and standardization of relevant factors to be used in pricing and hedging real estate assets. The model defines a new concept of randomness called multi-factorial causal random walk to be used for modelling real estate prices. This concept represents for real assets what the random walk based on the Brownian motion is for financial assets.

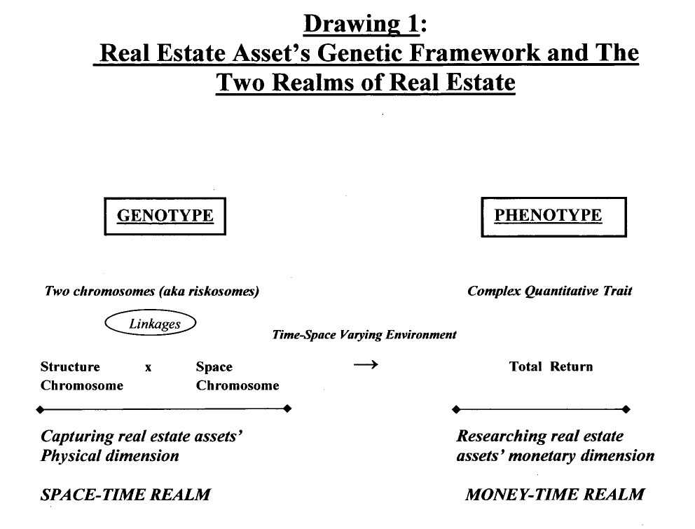

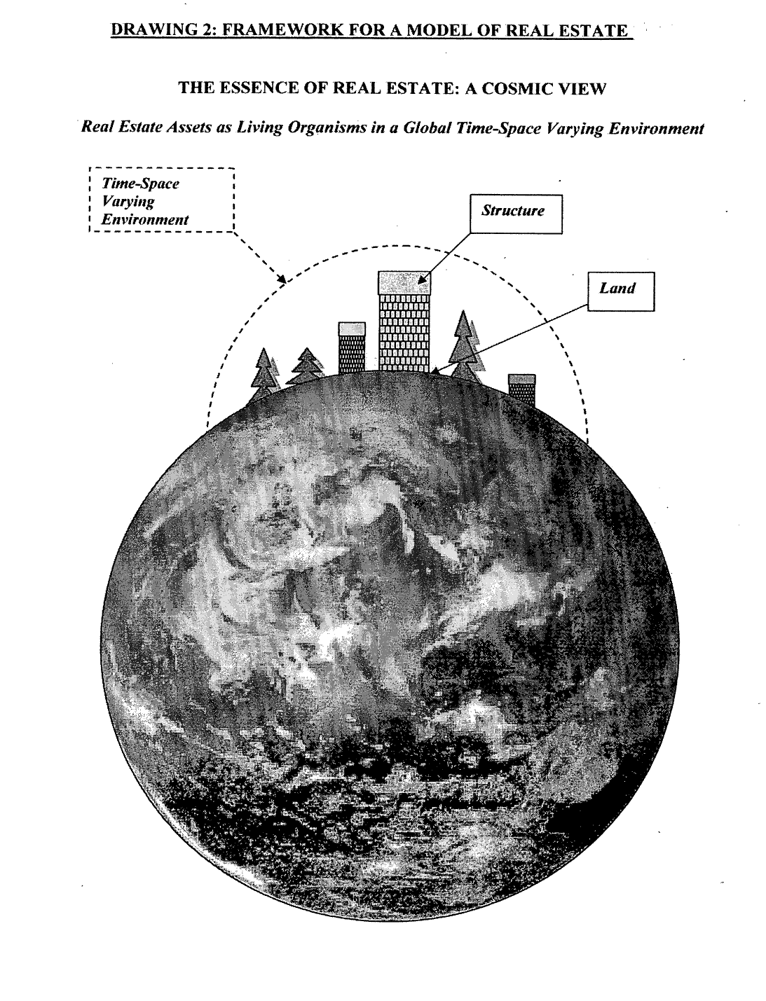

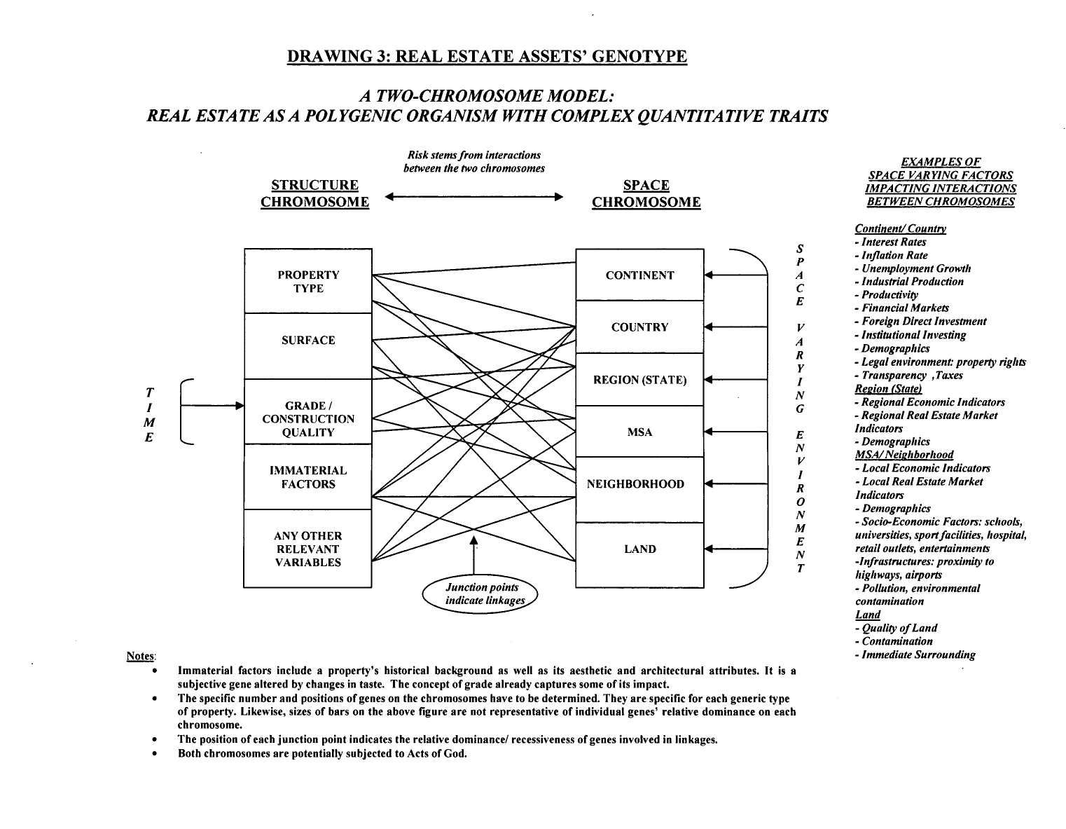

### CROSS REFERENCE TO RELATED APPLICATION

This non-provisional application for patent is claiming the benefit of the provisional application No. 60/907,515 filed on Apr. 5, 2007.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable

### BACKGROUND OF THE INVENTION

Real estate assets are part of a category of assets called heterogeneous assets. Each property is different and as a result it is difficult to derive a consistent pricing model for real estate assets. Because of the lack of standardization and the overwhelming idiosyncratic nature of real estate assets, it has been impossible to determine the factors impacting properties' value. This inability has prevented real estate to reach the mainstream of investments such as financial assets whose pricing is determined by well-understood models such as the Capital Asset Pricing Model or the Arbitrage Pricing Theory.

A thorough risk analysis is a prerequisite to the standardized pricing and hedging of real estate assets. In particular, it is necessary to design a model that captures the essence of real estate assets as intrinsically idiosyncratic.

### REFERENCES INCLUDE

Bachelier L. Theorie de la Speculation (Thesis), Annales Scientifiques de l'Ecole Normale Superieure (1900). English translation—Cootner (ed) (1964) Random Character of Stock Market Prices, Massachusetts Institute of Technology.
Hoag J. Towards Indices of Real Estate Value and Return. Journal of Finance, 1980, 35:2, 1980.
Lancaster K. A New Approach to Consumer Theory. Journal of Political Economy, 74:2, 1966.
Lecomte P. Beyond Index-Based Hedging: Can Real Estate trigger a New Breed of Derivatives Market? Journal of Real Estate Portfolio Management, Vol. 13:4, 2007.
Ling D. A Random Walk Down Main Street: Can Experts Predict Returns on Commercial Real Estate? Journal of Real Estate Research, 27:2, 2005.

### BRIEF SUMMARY OF THE INVENTION

The specification presents an innovative framework for modelling real estate risk. This framework enables the identification and standardization of relevant indicators to be used in pricing and hedging real estate assets. The model envisions real estate assets as conceptual entities within a network of causal inferences and environmental relations by positioning building in a varying time-space environment.

The model proposes a new definition of randomness in real estate prices based on genetics. This concept represents for real assets what the random walk based on the Brownian motion is for financial assets.

### BREIF DESCRIPTION OF THE SEVERAL VIEWS OF THE DRAWING

The specification contains three drawings numbered from 1 to 3 and attached with this document. Each drawing is one page long.

Drawing 1 illustrates the genetic framework used in the model for real estate risk.

Drawing 2 describes real estate assets as entities immersed in a global time-space varying environment.

Drawing 3 presents a model of real estate assets' genotype with two chromosomes, one for structure and another one for space.

### DETAILED DESCRIPTION OF THE INVENTION

This section of the specification presents the concepts applied in the process of making the invention (paragraphs [011] to [013]), the genetic framework used for modelling real estate assets (paragraphs [014] to [024]), and the concept of multi-factorial causal random walk (paragraphs [025] to [026]).

The model described in this application is an extension of the analysis used in ‘factor hedging’ (Lecomte, 2007 and U.S. patent pending Ser. No. 11/505,974 filed on Aug. 18, 2006) which characterizes real estate risk as a multi-factorial disease. The focus is on understanding the variations of risk defined as a complex phenomenon affecting a population of buildings considered as living organisms. The objective is to determine which underlying factors present in the population of assets, or combination of factor(s) and the environment, trigger the variability in returns.

To identify networks of risk factors that modulate the variability of returns in diverse environments, the model first defines the concept of risk in real estate investments. A property delineates two different though complementary spaces: the inside which encompasses the structure and location of the property (i.e. static component) and the outside (i.e. the environment). The model states that risk does not lie within a property. Risk stems from the interactions between the inside and the outside. As such, real estate risk is a dynamic process implying complex causal relationships involving an asset's static component and its environment.

Because of its essentially dynamic nature, real estate risk cannot be properly captured by static variables such as those usually used in hedonic regression models. The model considers that risk does not lie in time or space variables but rather in the interactions between an asset's static component and its time-space varying environment. The time-space environment (which is global) triggers an intricate network of apparently incoherent phenomena between the inside and the outside, which ultimately affects the asset's ability to generate predictable returns. Time is a catalyst in the risk process by interacting with space to define a time-space varying environment.

The model proposes a dynamic framework encompassing both real estate assets' essential physical and spatial dimensions. It uses a genetic framework that differentiates between genotype and phenotype as shown on drawing 1. The term ‘riskosome’ used in drawing 1 designates an asset's chromosome.

Genotype and phenotype are two extremely useful concepts in the characterisation of complex organisms insofar as they make it possible to differentiate between what is essentially intrinsic and what is only phenomenological.

In the model, the phenotype is an asset's risk measured by the variability of its total return while the genotype encompasses the constitution of a real estate asset or its static component. Phenotype and genotype capture the two realms of real estate in a single model: phenotype pertains to the money-time realm while genotype positions real estate assets in the space-time realm (drawing 1).

The next level of the model goes further down into the make-up of real estate assets by modelling their static components. A property's static component corresponds to its genetic material. It is akin to an organism's genome made up of chromosomes, genes and DNA.

A property is basically a structure delineating an inside space. Drawing 2 shows that the structure is built on a piece of land which defines a property's location and its environment.

In the model presented in the specification, a property's genome contains two chromosomes: a structure chromosome and a space chromosome. This is a two-chromosome model only. In case the model is extended to other heterogeneous asset classes, it might be necessary to add one or several other chromosomes characterizing the asset types. Drawing 3 summarizes the analysis.

The model positions real estate assets as polygenic organisms (i.e. multiple genes) with complex quantitative traits (i.e. multi-factorial phenotype expressed in continuous quantitative terms and implying complex interactions between genes and the environment).

Risk does not stem from static factors but depends from interactions or dynamic linkages between structure genes and space genes in a given time-space varying environment. In genetics, linkage refers to the association of genes located on the same chromosome. In the model presented in this paper, linkages represent interactions among genes irrespective of their chromosomes of origin.

As shown in drawing 3, the model considers that a real estate asset's DNA includes not only genes linked to the asset's physical nature (e.g. property type, grade) but also genes linked to variables having no immediate physical link with the asset's material entity (e.g. region, country, continent). By definition, the structure chromosome is endogenous (i.e. changes in genes are under the owner's control) whereas the space chromosome is subject to a myriad of exogenous influences. As a result, by anchoring a property in a specific environment, the space chromosome is the vector for most of the risk.

Age is neither a gene on the structure chromosome nor on the space chromosome. Time intervenes in the model as an external variable impacting the structure chromosome through the grade gene. Physical deterioration and obsolescence show up in the interactions between genes on both chromosomes. They disturb the causal relationships between the structure chromosome and the space chromosome either by modifying their impact on the phenotype or by creating new relationships which might be age-dependent. In this respect, maintenance, renovations and upgrades correspond to changes in genes on the structure chromosome undertaken in order to get the desired phenotype. These changes can also impact the space chromosome through externalities altering the neighbourhood gene.

In the dynamic linkages between genes from the same chromosome (structure on structure, space on space) or between genes on different chromosomes (structure on space, space on structure), some genes may be dominant over others.

The model proposes a new definition of randomness in real estate prices. Real estate assets' genome supposes that real estate pricing is deterministic. Prices depend on assets' genes, some of which cannot be easily altered or modified at all (e.g. land which is at the core of real estate's physical dimension). Hence, the model considers that the concept of unqualified random walk in real estate is an aberration. Genetics defines randomness in a way that is not fortuitous but causal since linkages have known impact on traits. Therefore, because of their essentially physical nature, real estate assets, and more generally all real assets, suppose a specific definition of randomness.

Genetics is to real assets what the Brownian motion is to financial assets, by defining and modelling randomness in prices. Random walk is a money-time concept that is not applicable as such to assets physically rooted in a space-time environment. For any given environment, variability in returns is deterministic, dependent on complex, though identifiable, patterns. Real assets follow a multi-factorial causal random walk.

Pages 11, 12 and 13 contain drawing 1, drawing 2 and drawing 3 described in paragraph [009] of the specification.

What is claimed is:

1. The model analyzes real estate risk based on a genetic framework that considers real estate assets as living organisms immersed in a time-space varying environment.

2. The model analyzes real estate risk as a complex multivariate phenomenon stemming from a network of dynamic interactions between an asset's structure chromosome and space chromosome (known as riskosomes), and environmental relations.

3. The model based on genetics defines the concept of multi-factorial causal random walk.
